(19) United States
(12) Patent Application Publication
(10) Pub. No.: US 2001/0027474 A1
(43) Pub. Date: Oct. 4, 2001

(54) Method for clientless real time messaging between internet users, receipt of pushed content and transacting of secure e-commerce on the same web page

(76) Inventors: Meny Nachman, Yehud (IL); Eytan Kunda, Ramat Hasharon (IL)

Correspondence Address: SIDLEY AUSTIN BROWN & WOOD, LLP, One World Trade Center, New York, NY, 10048-0557, US

(21) Appl. No.: 09/748,348

(22) Filed: Dec. 26, 2000

Related U.S. Application Data
(63) Continuation-in-part of application No. 09/476,492, filed on Dec. 30, 1999.

(51) Int. Cl. G06F 15/16

(52) U.S. Cl. 709/204

(57) ABSTRACT

A method for sending real-time messages between viewers of a WWW page without using a dedicated client program, transmitting content to such users and transacting secure e-commerce with such users. The system including a messaging module that notifies the messaging server of the users currently viewing a web page and provides auto-downloadable content from a server to any of a specific user, specific group or all users. The message module also provides secure e-commerce content to any of a specific user, specific group or all users.

### RELATED APPLICATIONS

This application is a continuation-in-part of application Ser. No. 09/476,492, which was filed on Dec. 30, 1999, and claims priority thereof.

### FIELD OF THE INVENTION

This invention relates to the field of telecommunications, and more particularly to a method that enables the viewers of a web page to communicate, in real-time, with others without a dedicated client software, and simultaneously receive pushed content from a webmaster and engage in secure e-commerce transactions with a webmaster.

### BACKGROUND OF THE INVENTION

The Internet is a vast network of computers interconnected by using the Internet Protocol (IP). The Transaction Control Protocol/Internet Protocol (TCP/IP) is the communications standard between hosts on the Internet. TCP/IP defines the basic format of the digital data packets on the Internet allowing programs to exchange information with other hosts on the Internet.

Computer users can access many resources on an expansive international network of computer networks known as the Internet. The World Wide Web (WWW) or the “web” is a graphical sub network of the Internet. Web pages include any document written in a mark up language including, but not limited to, HTML (hypertext mark-up language), VRML (virtual reality modeling language), WML (wireless mark-up language), dynamic HTML, XML (extended markup language) or related computer languages thereof, as well as any collection of such documents reachable through one specific Internet address or at one specific WWW site, or any document obtainable through a particular URL (Universal Resource Locater). With common “web browser” software of the type of Netscape Navigator or MS Internet Explorer browser, PC users can readily access Internet information or services provided by web servers on WWW. Additionally, with Wireless Application Protocol (WAP) micro-browsers, handheld device users can access such Internet information and services.

Over the past few years, a new type of client software applications has become increasingly popular. Such applications enable Internet users to exchange messages in real-time when on-line. Several instant messaging applications are well known, including ICQ (www.icq.com), MSN Messenger (messenger.msn.com) etc. Most instant messaging applications enable the user to maintain a contact list and communicate in real-time with their contacts. Another common feature enables a user to know if his contacts are currently on-line, thus reachable for instant messaging.

U.S. Pat. No. 5,943,478, issued to Sudhanshu Aggarwal (Aug. 24, 1999) discloses a system for sending immediate popup messages between Internet users, the system including a user interface for sending messages and displaying messages in popup windows similar to ICQ. Aggarwal does not discuss a system for instant messaging between the viewers of a wen page nor version thereof.

U.S. Pat No. 5,907,677, issued to Steve Glenn (May 25, 1999) discloses a method for establishing anonymous real-time communication links for secure private conversations between a plurality of subscribers.

PCT publication No. W09926153A2, filed by Min Zhu (Nov. 18, 1998) discloses a method for establishing a communication link between two or more users via the Internet, and, more specifically, a web-server based real-time data conferencing system. Under the preferred embodiment of Zhu et al., a user uses an application (such as a web browser) to retrieve and view a web page. On the web page (or the like), a clickable icon or hyperlink is provided to call another user or service. Under said method, there is no custom software on the user/caller side. The method disclosed by Zhu does not discuss instant messaging between Internet user on the same web page but rather a commercial call-center for exchange of information between a customer and an agent.

Hypernix Ltd. offers a client application under the trade name “Gooey” (www.gooey.com) that enables all the viewers of a web page, who use the Gooey client to interact and communicate as a natural, integrated part of the surfing experience. Novawiz Ltd. offers a similar client application under the trade name “Odigo” (www.odigo.com). Both client applications basically enable their users to (a) locate other people by their interest; (b) exchange messages with web users viewing the same web page; (c) as the owner of a web page, see who is visiting said web page; (d) know what web pages are popular at the moment; (e) find the most popular web sites by topic; (f) exchange files with other users; and more features are continuously added. ICQ has also released a new module under the trade name “ICQ Surf’ (www.icq.com/icqsurf) that extends the functionality of the plain instant messaging application and enables the users thereof to exchange messages with others based on the web page they are viewing at the moment.

The main drawback of all instant messaging client applications such the above mentioned is the need to have them downloaded and installed on each individual Internet user's computer. In addition, each user has to start (run) the application, while browsing the Internet. Practically, the need to use a dedicated client application significantly limits the user base of the service offered. Moreover, the competition between various software vendors, such as those mentioned above, further reduces the potential benefit to the user. In sum, the prior art does not disclose any method or system that enables real-time messaging between the viewers of a particular web page without using a dedicated, preinstalled client software application.

### SUMMARY, OBJECTS AND ADVANTAGES OF THE INVENTION

In general, in one aspect, the invention features a method that enables most of the functions of prior art dedicated client applications for instant messaging between the viewers of a web page, however without the need to download, install and run said application.

The invention includes a set of servers for managing, storing and routing communication between users, by utilizing existing features of the standard browsing applications used for viewing WWW pages over the Internet.

In the preferred embodiment, a plurality of Web Server Modules (WSM) is installed on a plurality of web servers using the HTTP (HyperText Transfer Protocol) and WAP (Wireless Application Protocol). Each WSM monitors all of the Internet users who view the same web page on the server and handles the exchange of messages between the users. At least one Web Messaging Central Server (WMCS) controls a set of WSM units and controls various aspects such as user authentication and provisioning of services for each class of users.

Accordingly, it is an advantage of the present invention that once a web page is configured to provide WSM functionality, all the viewers of said web page potentially become part of the user group that makes use of the service.

A further advantage of the present invention is that it employs a distributed architecture whereby most of the Internet traffic between the viewers of a web page is routed through the WSM of said web site, thereby reducing the need for a high capacity network such as the prior art instant messaging systems.

A still further advantage of the present invention is that it supports highly scalable logging features that provide means for monitoring Internet users browsing habits and web page preferences.

Another advantage of the present invention is that it transforms plain web pages to interesting forum for exchange of information and opinions.

Yet another advantage of the present invention is that it provides extensive graphic information to the web page owner with respect to the visitors of said web page and provides for content push including the sending of files, text, video and audio files as well as providing dynamic secure e-commerce windows for credit card transactions sent to the users.

Still another advantage of the present invention is that it enables web page visitor to leave notes to other visitors of the same page for later reference.

A further advantage of the present invention is the ability to use its database in order to build an accurate index for information retrieval, which is less prone to errors than regular search engines.

Another advantage of the present invention is that it enables large user communities to unite and achieve significant benefits, such as improved purchase power and bidding between users and with the webmaster as well as security within the e-commerce transactions.

Yet another advantage of the present invention is that it reduces the cost of setting up commercial web sites.

The foregoing and other objects, features and advantages of the invention will become more readily apparent from the following detailed description of a preferred embodiment, which proceeds with reference to the drawings.

### BRIEF DESCRIPTION OF THE DRAWINGS

FIG. 1 is an overview of an instant messaging system employing the present invention;

FIG. 2 illustrates the steps that establish a messaging link between web browsers and/or WAP micro-browsers;

FIG. 3 is a flow chart illustrating a typical process of a downloadable client side script;

FIG. 4 is a flow chart illustrating a typical process of a Web Server Module;

FIG. 5 is a flow chart illustrating a typical process of a downloadable client side applet;

FIG. 6 is a flow chart illustrating a typical process of an applet compatible Web Server Module;

FIG. 7 is a table describing the records maintained by a typical WSM;

### DETAILED DESCRIPTION OF THE PREFERRED EMBODIMENT

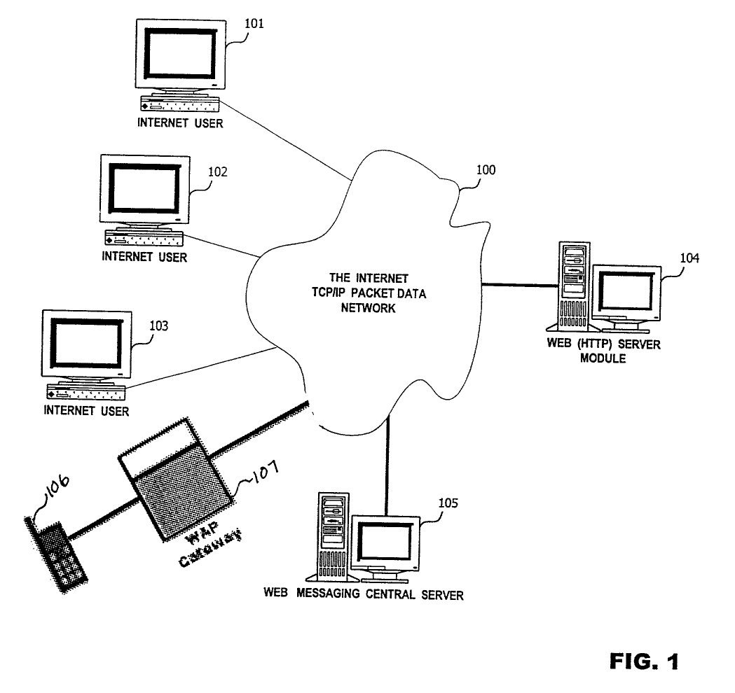

Having reference now to the drawings, in FIG. 1, there is shown a packet switching TCP/IP network generally referred to as the Internet, designated by the reference character 100. As shown in FIG. 1, a plurality of computers 101-103 and at least one hand held device 106 (e.g. a cellular phone, palm pilot or the like) is connected to the Internet. Each computer 100-103 comprises a central processing unit with all accessory devices running an operating system and Internet web browser program that communicates over the Internet by using the HTTP protocol through a communication adapter. The at least one hand held device 106 comprises a central processing trait running an operating system and browser program that communicates over the Internet by using WAP via WAP Gateway 107. The users of computers 101-103 and hand held device 106, all open a web page stored on web server 104, which is also connected to the Internet. Web server 104 listens to the HTTP and WAP requests and provides HTTP and WAP responses in the form of HTML and WML pages, respectively, and other files such as images, audio and video files, which are then displayed or played on the requesting computer. On the same server computer running the web server, a Web Server Module (WSM) is installed and running. Configured to operate in conjunction with the web server, the WSM enables instant messaging and further functions between the users of computers 101-103 currently viewing the same web page or site on server 104. A plurality of WSM entities on different web servers communicate over the Internet with at least one Web Messaging Central Server (WMCS) 105, which provides various functions such as user identification and logging.

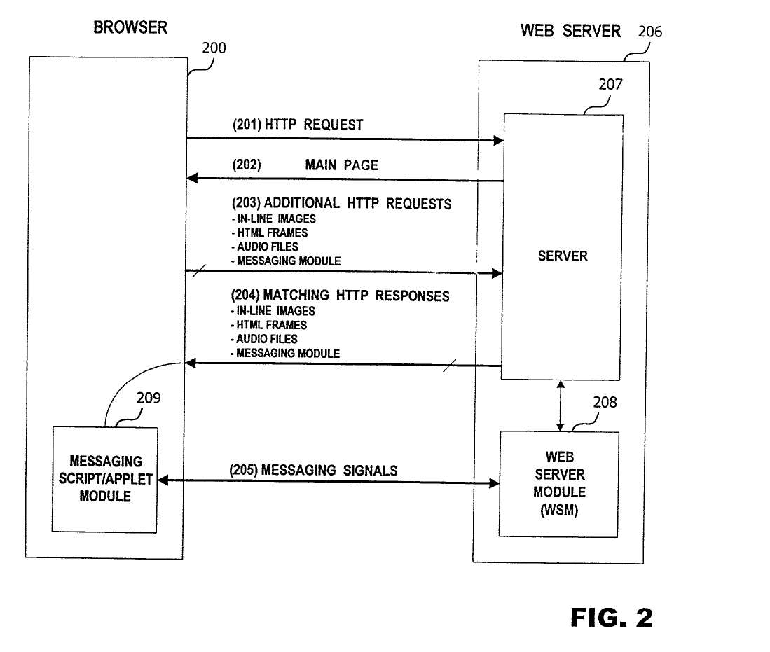

Referring now to FIG. 2, a typical HTTP session between a web or WAP browser 200 and a web server 206 in accordance with the present invention may include the steps of an HTTP request 201 originated by the web or WAP browser 200 and sent over the TCP/IP network to the server 207 on the proper TCP port (usually port 80). The WAP request 201 originated by WAP browser 200 is sent to the TCP/IP network via a w tar gateway, wherein it is converted to an HTTP request. The server 207 processes the request and replies back with an HTTP response 202 typically comprising at least one main page written in HTML or WML, which depends on whether the receiving device is a web or WAP browser, typically containing formatted text and links to other in-line files to be automatically requested by the web or WAP browser 200. When the HTTP response is sent back to the WAP browser it is converted to a WAP response by the WAP Gateway.

The web or WAP browser 200 processes the main HTML or WML page, respectively, and issues additional HTTP or WAP requests 203, respectively, as set out by the main HTML or WML page. Said additional requests may include in-line image files to be displayed on the web or WAP browser 200, audio files to be played, further HTML or WML frames to be displayed, Java applets to be executed and any other file type supported by said web or WAP browser 200. The server 207 fulfills said additional HTTP requests with matching HTTP responses 205. Accordingly, the HTTP request issued for the download of a messaging module 209 results in the loading of said module on the web or WAP browser 200.

The messaging module 209 may take the form of a dedicated HTML or WML frame, a JavaScript coded script, a WMLScript coded script, a VBScript coded script, a Java applet, an Active-X control or any other executable content that does not require a dedicated download and installation process. Upon loading, the messaging module 209 communicates with the WSM 208 typically installed on the same web server as the HTTP server and exchanges signaling in accordance with the present invention.

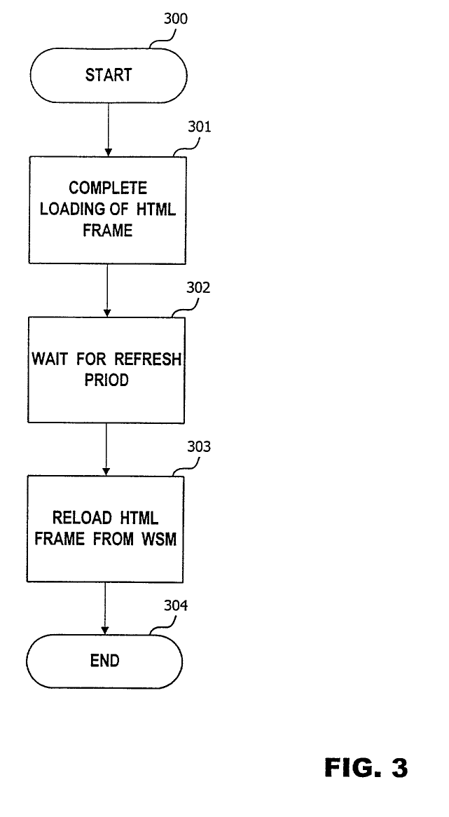

Referring now to FIG. 3, in one embodiment of the present invention, a hidden HTML or WML frame serves as part of the messaging module. In a typical web page, the hidden frame would not be displayed on the browser screen. Upon loading the hidden frame 300 sent from the WSM in response to a corresponding web page's HTML or WML code, the frame completes all the page initialization tasks as specified in the hidden frame's code 301. The browser waits for a predefined delay period 302, which is the hidden frame's refresh rate. After the delay, another HTTP request 303 is issued to the WSM, thereby notifying that said user is still on the same web page. Upon the refresh 304 of the hidden frame, another substitute-hidden frame is loaded. The hidden frame's refresh rate is a tradeoff of Internet traffic load and tracking resolution of online web page viewers. A sample HTML code of the hidden frame may be:

<META HTTP-EQUIV=“Refresh” CONTENT=“20; URL=http://www.wsm.com/”>

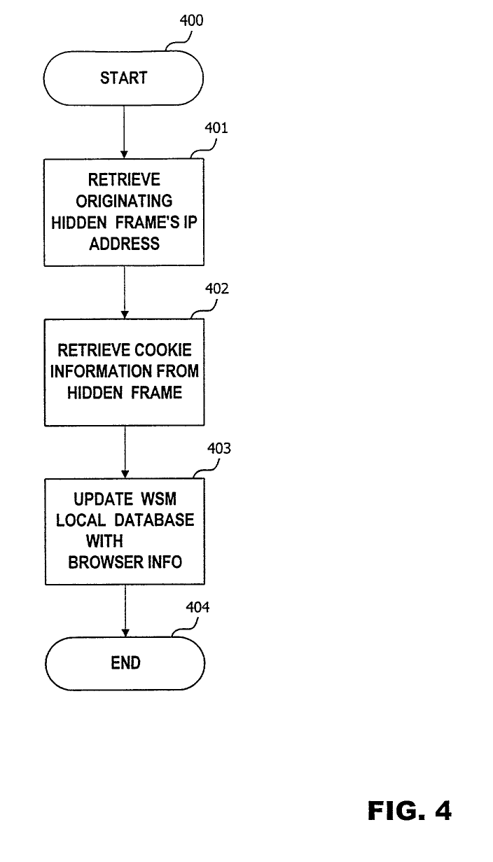

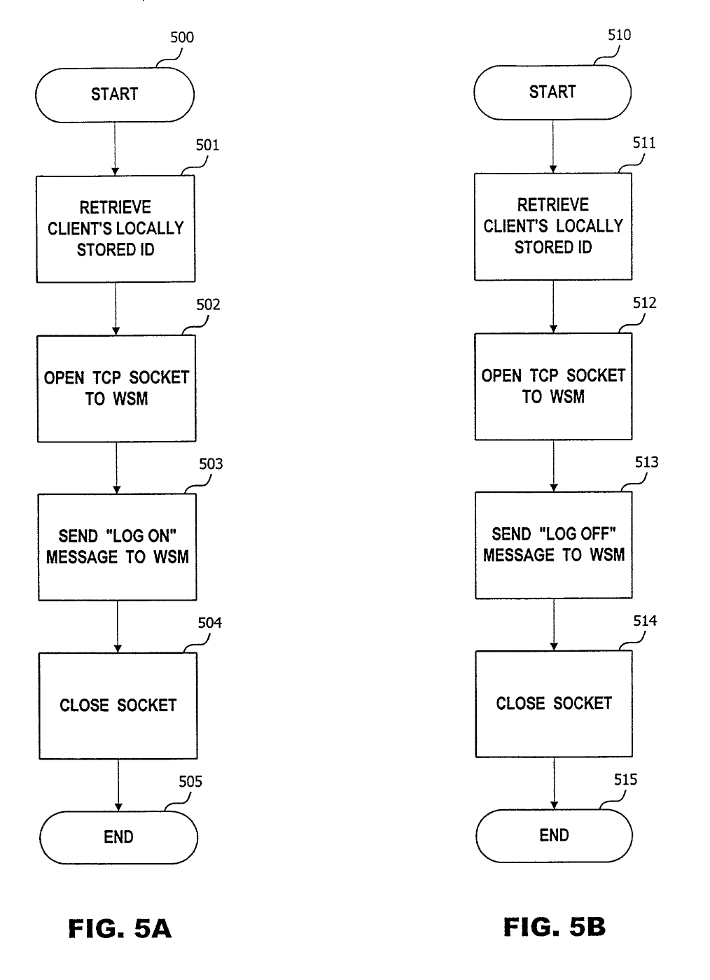

Referring now to FIG. 4, a server side script or application receives ongoing HTTP requests from a plurality of hidden frames as described above. Upon listening to such request, the server side script starts 400 and reads the IP address of the originating web or WAP browser 401. Such information can be retrieved from the HTTP headers of said HTTP request. In the event that the system has further information on said web or WAP browser; such information would be retrieved in the form of HTTP cookies 402 recorded on the client's browser. The script updates 403 the WSM local database with the details of the user of the user currently viewing a certain web page and then terminates 404. Referring now to FIG. 5A, in another embodiment of the present invention, a Java applet is used instead of an auto refreshing HTML page. Upon loading of an HTML page from the web server, the Java applet is started 500. The Java applet retrieves the web or WAP browser's locally stored identification information 501 such as the current IP address used by the browsing computer and other information that identifies the user with the WSM. A TCP socket connection is opened to the WSM 502, a “log on” command is sent to the WSM 503 including all relevant identification information related to said client. The opened TCP socket is then closed 504 to free system resources and the process terminates 505. Upon leaving the currently viewed web page, a “close” event starts the process illustrated in FIG. 5B, which follows steps 510-515 similar to those of the “log on” process but intended to notify the WSM that the web or WAP browser is no longer on said web page (“log off’).

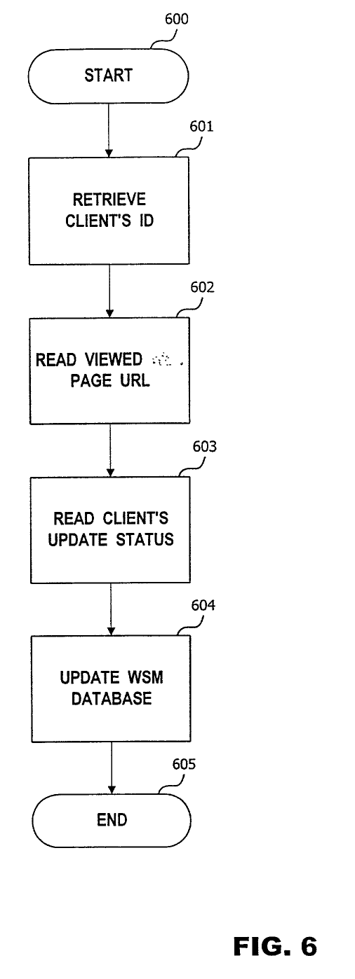

Referring now to FIG. 6, a server application running on the WSM listens to connections originating in a plurality of messaging modules loaded onto web or WAP browser applications in accordance with FIG. 5 above. Upon the opening of a TCP socket, the server process typically starts 600. The server application reads various details sent over the EP link, including the client identification details 601, the URL of the web page currently viewed by said web or WAP browser 602, the browsing status (log on/off) 603. The process updates the specific client's status on the WSM's memory 604 and then terminates 605. It should be understood that the process. illustrated in FIG. 6 can be executed either on the same server machine running the HTTP/WAP server but this is not a mandatory requirement, as the messaging module may be configured to operate with a WSM having a different IP address than the HTTP/WAP server.

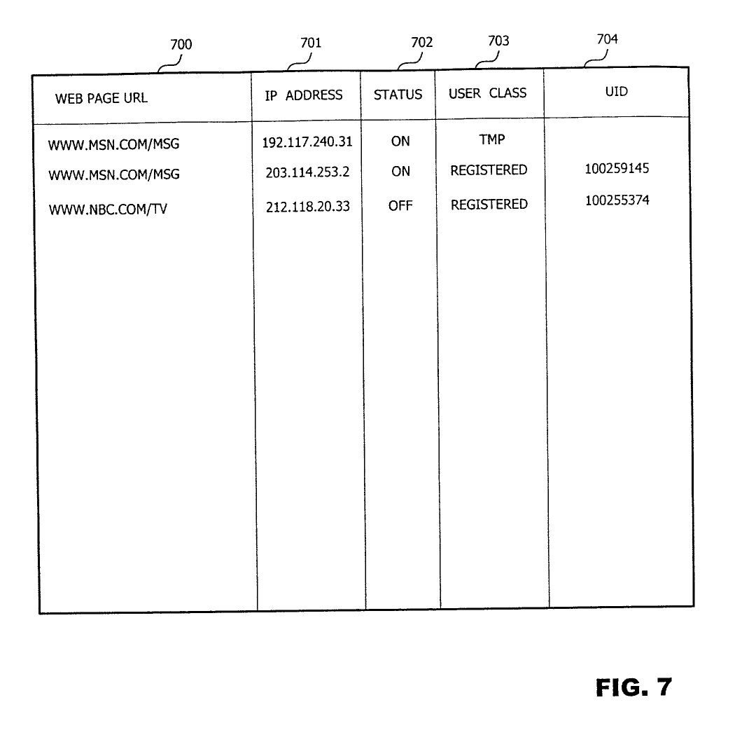

In the representative embodiment, each WSM maintains its own database of web and WAP browser clients, which are continuously monitored while browsing the web pages covered by said WSM. Such database may be managed either in the WSM machine's RAM, file system or by using a dedicated SQL server depending on the load and expected performance. FIG. 7 depicts a typical WSM table wherein column 700 records the web page complete URL; column 701 records the EP address of the client's browser; column 702 specifies the status of the browser (logged on/off); column 703 specifies the user's class (registered/temporary) and column 704 records the user ID of registered users. It should be noted that the table described herein may include further details as may be required to enable various functions such as those offered by prior art instant messaging applications.

When browsing a web page supported by the system of the present invention, a user has a link or button, whereby it is possible to receive a list of other users watching the same web page. Upon clicking said link or button, an HTTP query is submitted onto the WSM, which in return provides a list of currently logged on users. Said list may either be displayed as a web page or by a Java applet, depending on the exact implementation. Any Internet user who makes use of the invention is invited to register by providing certain information such as name, age, gender, country of origin, e-mail address etc. User registration can be realized by means of a web page including HTML or WML forms as known to those skilled in the art. Once registered, user details are stored on the Web Messaging Central Server (WMCS). In one embodiment of the present invention, user information may also be stored on the client browser program by means of HTTP or WAY cookies. Upon registration, the UID code assigned to the user is stored on the web browser's cookie file and on each access to a WMS, the UID code serves to identify the user according to the registered details included in the WMCS database.

After requesting a list of other Internet users in a given web page, the requesting user may send a pop-up message to one or more users on said list. In the preferred embodiment, the user wishing to send a message marks the details of the recipients) and clicks the COMPOSE MESSAGE button. An HTTP form is then displayed, wherein message details are to be entered. Once message text is entered, the user clicks SEND MESSAGE. Another HTTP form is submitted onto WMS, which in turn notifies recipients) that a message has arrived thereto. In the event that recipient uses an HTML or WML based messaging module, upon each refresh of the HTML or WML frame, WMS has the ability to display messages from the WMS. Since the messaging module's frame is typically hidden, a pop-up HTML or WML window may be used. In the event that a Java applet based messaging module is used, WMS opens a socket connection to the recipient's messaging module, thereby informing of an incoming message to be displayed.

It is understood, however, that the server may also send a pop-up message including text, video and audio files as well as provide secure e-commerce pages for credit card transactions to a specific user, specific group or all users. Such messages are part of messaging module 209 and may take the form of a dedicated HTML or WML frame, a JavaScript coded script, a WMLScript coded script, a VBScript coded script, a Java applet, an Active-X control or any other executable content that does not require a dedicated download and installation process. In such an embodiment, the server loads the applicable URL of the message into the applicable window of a web or WAP browser to the appropriate recipient. Alternatively, the server can push the message within a frame of the window. Further, to ensure that the content is displayed properly, it may be necessary to add JavaScript or Active-X control to the content.

Once registered with a WMCS, a user may define that when entering web sites covered by a WMS, its details be disclosed in whole or in part. A user may also configure a class or list of web sites for which its details are to remain undisclosed and upon entering such sites the user will be counted as a non-registered anonymous user.

In one embodiment of the present invention, a messaging module employs encryption and authentication means such as public key cryptography in order to maintain the confidentiality of messages between users and messages between users and the server. Said security measures may be based on standard web browsing features such as SSL (Secure Sockets Layer) as disclosed in U.S. Pat No. 5,657,390, issued to Taher Elgamal (Aug. 12, 1997) and assigned to Netscape Communications Corporation. As commercial unsolicited e-mail (a.k.a. SPAM) has become an increasingly controversial issue, many messaging systems including prior art instant messaging systems employ means for filtering unwanted messages including specific information and/or originating in problematic sources. The system of the present invention realizes similar filtering mechanism within WMS and WMCS in order to protect legitimate users from misuse of the system by spammers.

Moreover, when a user is engaged in an e-commerce transaction with the server, the message is sent to a user in the same manner described above with regard to the sending of messages from the server to the user. Additionally, because of the security concerns involved in e-commerce such an e-commerce message providing for the input of user credit car information employs the encryption and authentication means mentioned above. Furthermore, with regard to decryption and encryption of such messages the server runs an algorithm that performs the functions of mixing up the format of such messages into unreadable text and then reformatting such messages into readable text. In particular, the message is encrypted by the server software before being sent by the server to the browser and is decrypted by the server software at the browser for presentation to the user viewing the browser window. Moreover, the message includes dynamic html format including JavaScript and Active-X control to present the e-commerce message to the user live, in real-time.

Based on a variety of tools available for Internet messaging by using only browsers, such as Java based chat rooms, Internet phones utilizing voice over EP technologies and videoconferencing, it is possible to enables two or more Internet users to communicate, in real-time, and exchange information, while on the same web site, without having to download a dedicated software application.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed is:

1. A method of real-time transmission of content to at least two browsers displaying a WWW page hosted by a predefined server, said method comprising the steps of:
maintaining a list of browsers viewing said WWW page at the server and
loading a message module including a message onto each browser displaying said WWW page.

2. The method of claim 1, wherein said message module is a Java applet.

3. The method of claim 1, wherein said message module is an Active-X control.

4. The method of claim 1, wherein said message module comprises at least one of JavaScript code, VB Script code and WMLScript code.

5. The method of claim 1, wherein said message module is encrypted.

6. The method of claim 1, wherein said message is a formatted text message.

7. The method of claim 1, wherein said message is a file.

8. The method of claim 1, wherein said message is an audio file.

9. The method of claim 1, wherein said message is a video file.

10. The method of claim 1, wherein said message is a secure e-commerce file.

11. The method of claim 1, wherein said message further includes an attached file.

12. The method of claim 1, further comprising the step of storing registered users' information in a database of a central server.

13. The method of claim 1, further comprising the step of storing a plurality of messages sent from the server to each of a plurality of users in a database of a central server.

14. The method of claim 13, further comprising the step of storing the response messages received from each of the plurality of users in the database.

15. The method of claim 1, wherein said at least two browsers include at least one of a web browser and a WAP browser.

16. A method of real-time transmission of content to at least one browser displaying a WWW page hosted by a predefined server, said method comprising the steps of:
maintaining a list of browsers viewing said WWW page at the server;
encrypting a message at the server; loading a message module including the message onto each browser displaying said WWW page;
and decrypting said message at said at least one browser.

17. The method of claim 16, wherein said message module is a Java applet.

18. The method of claim 16, wherein said message module is an Active-X control.

19. The method of claim 16, wherein said message module comprises at least one of JavaScript code, VB Script code and WMLScript code.

20. The method of claim 16, wherein said message is a formatted text message.

21. The method of claim 16, wherein said message is a secure e-commerce file.
